(19) United States
(12) Patent Application Publication
(10) Pub. No.: US 2026/0187396 A1
(43) Pub. Date: Jul. 2, 2026

(54) DISPLAY MEDIUM OF INFORMATION CODE, INFORMATION CODE GENERATION DEVICE, AND INFORMATION CODE READING DEVICE

(71) Applicant: DENSO CORPORATION, Kariya-city (JP)

(72) Inventors: Shinichi KIKUCHI, Kariya-city (JP); Koichi NAKAO, Kariya-city (JP); Tatsuya OKABE, Kariya-city (JP); Mitsuo OKUMURA, Kariya-city (JP)

(21) Appl. No.: 19/544,040

(22) Filed: Feb. 19, 2026

Related U.S. Application Data
(63) Continuation of application No. PCT/JP2024/028425, filed on Aug. 8, 2024.

(30) Foreign Application Priority Data
Aug. 23, 2023 (JP) 2023-135927

(51) Int. Cl. G06K 7/14

(52) U.S. Cl. CPC G06K 7/1495; G06K 7/1478

(57) ABSTRACT

An information code includes a first code representing first information and a second code representing second information, which are recorded in a two-dimensional region in a superimposed manner. The first code displayed in the two-dimensional region is readable by performing a brightness determination using a first reading method. The second code displayed in the two-dimensional region is readable by a second reading method different from the first reading method. In the second code, an arrangement of multiple colored cells is defined such that a result of the brightness determination performed using the first reading method is maintained. Among the first code and the second code, the first code expresses data in an uncompressed format and is displayed in a smaller display area compared with the second code. The second code expresses data in a compressed format for compressing a display area.

### CROSS REFERENCE TO RELATED APPLICATION

The present application is a continuation application of International Patent Application No. PCT/JP2024/028425 filed on Aug. 8, 2024, which designated the U.S. and claims the benefit of priority from Japanese Patent Application No. 2023-135927 filed on Aug. 23, 2023. The entire disclosures of all of the above applications are incorporated herein by reference.

### TECHNICAL FIELD

The present disclosure relates to a technology of providing highly convenient information code.

### BACKGROUND

There has been known an information code that records a first code representing first information and a second code representing second information in a common two-dimensional region in superimposed manner.

### SUMMARY

According to an aspect of the present disclosure, an information code includes a first code representing first information, and a second code representing second information. The first code and the second code are recorded in a two-dimensional region in a superimposed manner. The first code is displayed in the two-dimensional region and is readable by performing a brightness determination using a first reading method. The second code is displayed in the two-dimensional region and is readable using a second reading method, which is different from the first reading method. In the second code, an arrangement of multiple colored cells is defined under a condition that a result of the brightness determination performed using the first reading method is maintained when reading the second code using the second reading method. Among the first code and the second code, one code may express data in an uncompressed format and is displayed in a smaller display area compared with the other code, and the other code may express data in a compressed format for compressing a display area of the other code.

### BRIEF DESCRIPTION OF DRAWINGS

The present disclosure will become apparent from the following detailed description made with reference to the accompanying drawings. In the drawings:

FIG. 1 is a diagram showing an item code, a tracking code, and a synthesized information code;

FIG. 2 is a diagram showing a traceability system together with a distribution management system;

FIG. 3 is a flowchart showing an example of a code generation process;

FIG. 4 is a flowchart showing an example of a code reading process;

FIG. 5 is a diagram showing an item code, a tracking code, and a synthesized information code;

FIG. 6 is a diagram showing a function pattern;

FIG. 7 is a flowchart showing an example of a code generation process;

FIG. 8 is a flowchart showing an example of a code reading process; and

FIG. 9 is a diagram showing an information code.

### DETAILED DESCRIPTION

In an information code, suppose that an area of display region of the first code is different from an area of display region of the second code in size. In this case, if the two codes are simply superimposed, the display region for superimposition needs to be adjusted to match the larger code. However, when a display layout of a code with a small display region is to be reused and a code with a larger display region is to be added to the display layout of the small code, a problem occurs in that the information code after superimposition does not fit into the display layout. For this reason, there is a demand for further improvement in convenience.

According to an aspect of the present disclosure, an information code includes a first code representing first information, and a second code representing second information. The first code and the second code are recorded in a two-dimensional region in a superimposed manner. The first code is displayed in the two-dimensional region and is readable by performing a brightness determination using a first reading method. The second code is displayed in the two-dimensional region and is readable using a second reading method, which is different from the first reading method. In the second code, an arrangement of multiple colored cells is defined under a condition that a result of the brightness determination performed using the first reading method is maintained when reading the second code using the second reading method. Among the first code and the second code, one code expresses data in an uncompressed format and is displayed in a smaller display area compared with the other code, and the other code expresses data in a compressed format for compressing a display area of the other code.

According to another aspect of the present disclosure, an information code generation device includes at least one processor. The at least one processor is configured to generate an information code in which a first code representing first information and a second code representing second information are recorded in a two-dimensional region in a superimposed manner. The at least one processor is further configured to: generate the first code that is readable by performing a brightness determination using a first reading method; and generate the second code. In generation of the first code and the second code, one code is generated to express data in an uncompressed format and displayed in a smaller display area compared with the other code, and the other code is generated to express data in a compressed format for compressing a display area of the other code. The at least one processor is further configured to synthesize the first code and the second code based on a synthesis rule, which enables the second code to be readable by a second reading method, which is different from the first reading method. In the second code, an arrangement of multiple colored cells is defined under a condition that a result of the brightness determination performed using the first reading method is maintained when reading the second code using the second reading method.

In the above aspects, for one code in which each data is expressed in an uncompressed format, an uncompressed format is adopted such that the code can be expressed in a smaller display area. For the other code, a compressed format is adopted such the display area of the code can be compressed. By creating a difference between the uncompressed format and the compressed format, the difference between the display area of the first code and the display area of the second code can be reduced. The display area of the information code after superimposition can be adjusted to be the same as or close to one code that can be expressed with a smaller display area. Therefore, the applicability of the superimposed information code to the display layout can be improved, thereby providing improved convenience.

According to another aspect of the present disclosure, an information code reading device includes at least one processor. The at least one processor is configured to read an information code in which a first code representing first information and a second code representing second information are recorded in a two-dimensional region in a superimposed manner. The information code includes white cells, black cells, light color cells, and dark color cells. The at least one processor is further configured to: read the first code by performing a brightness determination using a first reading method in which (i) the white cells and the light color cells are determined to have a same value and (ii) the black cells and the dark color cells are determined to have a same value; read the second code by performing a brightness determination using a second reading method in which (i) the white cells and the dark color cells are determined to have a same value (ii) and the black cells and the light color cells are determined to have a same value; and in at least one of reading the first code or reading the second code, identify one code expressed in a compressed format in which a display area of the one code is compressed and read information stored in the one code according to a compressed mode of the compressed format.

In the above aspect, when a code expressed in a compressed format in which the display area is compressed is identified, information is read out in accordance with the compression mode of the compressed format. Therefore, when reading the information code in which the first code and the second code are superimposed, it is possible to obtain the information correctly even if the data of at least one of these codes is expressed in a compressed format. Therefore, this configuration can provide improved convenience.

Hereinafter, multiple embodiments will be described with reference to the drawings. The same reference symbols are assigned to the corresponding elements in each embodiment, and thus, duplicate descriptions may be omitted. When only a part of the configuration is described in one embodiment, the remaining part of the configuration may adopt the remaining part of the configuration described in the foregoing embodiments. Further, not only the combinations of the configurations explicitly shown in the description of the respective embodiments, but also the configurations of the multiple embodiments can be partially synthesized even if they are not explicitly shown if there is no problem in the combinations in particular.

### First Embodiment

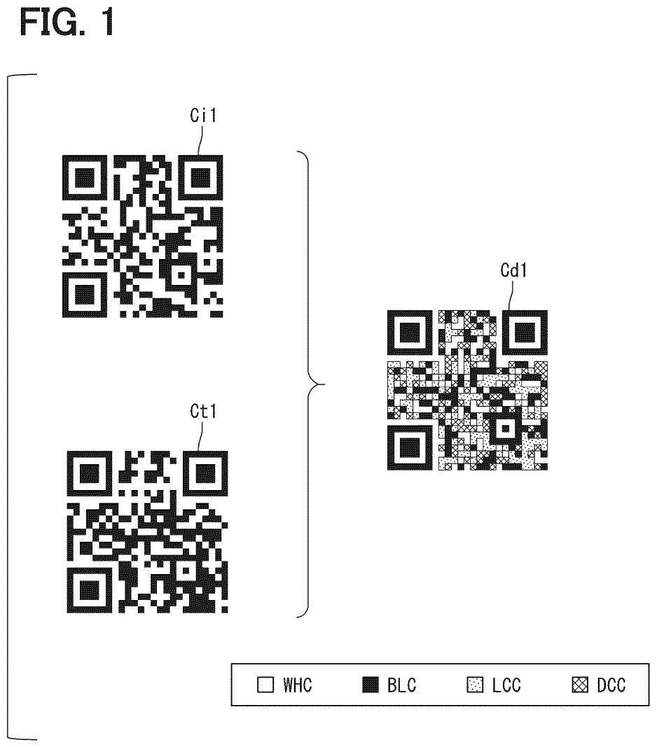

As shown in FIG. 1, an information code Cd1 according to a first embodiment of the present disclosure is generated by a process of combining two two-dimensional codes. The information code Cd1 stores two two-dimensional codes superimposed on a common two-dimensional region. The two-dimensional codes that are the basis of the information code Cd1 may be QR codes (registered trademark), and record information using a two-dimensional array of multiple cells. The information code Cd1 can be printed on a paper medium or the like and used in the form of a code printed medium such as a label, a sticker, or a tag. The information code Cd1 may be displayed on a display device, such as a display or electronic paper.

The information code Cd1 is generated by combining a public code (for example, an item code Ci1) and a secret code (for example, a tracking code Ct1). When the information code Cd1 is read using a normal reading device, such as a code reading device 13 to be described below, the information code Cd1 is recognized as a public code. In this case, information recorded in the public code Cd1 (hereinafter referred to as public information) is read by the code reading device. The secret code needs to be read by a special reading device, such as a code scanner 23 to be described below. In this case, information recorded in the secret code Cd2 (hereinafter referred to as secret information) is read by the code scanner.

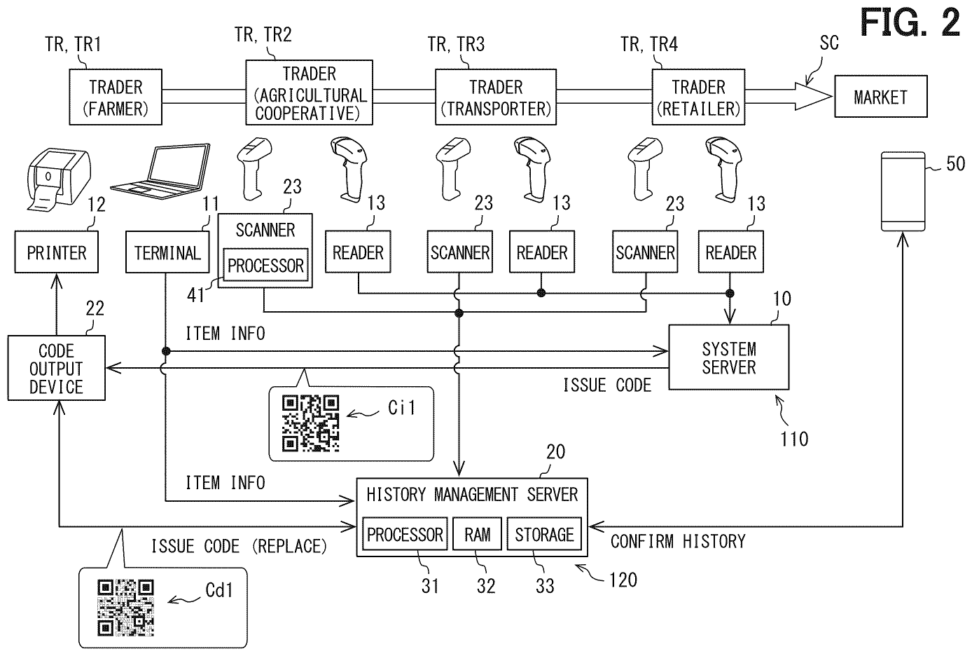

The information code Cd1 is used in both the distribution management system 110 and a traceability system 120. The distribution management system 110 and the traceability system 120 are management systems that manage a supply chain SC that includes a large number of traders TR. The supply chain SC is a connection between the traders TR for delivering, for example, industrial products, agricultural products, and marine products to consumers. As an example, as shown in FIG. 2, in the supply chain SC for delivering an agricultural product to a consumer, the traders TR includes a farmer TR1, an agricultural cooperative TR2 that is a collection facility, a transporter TR3, and a retailer TR4.

The distribution management system 110 collects records of item transactions between traders TR using the item codes Ci1. In other words, the item code Ci1 is managed by the distribution management system 110. The distribution management system 110 includes an input terminal 11, a label printer 12, a code reading device 13, and a system server 10. The label printer 12 and the code reading device 13 are appropriately installed in a facility of each trader TR. The input terminal 11, the label printer 12, and the code reading device 13 are communicably connected to a system server 10 installed in a data center via a network.

For example, the input terminal 11 is a personal computer or a tablet terminal. Basic information of the item (hereinafter referred to as item information) provided to the supply chain SC is input to the input terminal 11 according to a predetermined format. For example, the item information includes an article name, a production place, a production facility, and a producer. The input terminal 11 transmits, to the system server 10, the item information of the item shipped from the trader TR.

The label printer 12 is an output device for printing the item code Ci1 on a paper medium. The label printer 12 is configured to perform color or grayscale printing. The paper medium on which the item code Ci1 is printed is attached to the package or outer box of the transaction item to be shipped, and is delivered as an attachment to the item.

The code reading device 13 is configured to read the item code Ci1 to obtain the public information recorded in the item code Ci1. The code reading device 13 acquires the public information recorded in the item code Ci1, and transmits the acquired public information to the system server 10.

The system server 10 is a host node capable of communicating with the input terminal 11, the label printer 12, and the code reading device 13. The system server 10 registers the item information acquired from the input terminal 11 in a database. The system server 10 prepares public information associated with the item information, and generates an item code Ci1 that records the public information. In the process of issuing the item code Ci1, the system server 10 transmits image data of the generated item code Ci1 to the label printer 12, which is provided in a transmission source of the item information. When the issued item code Ci1 is distributed together with the item and is read by a code reading device 13 of another trader TR, the system server 10 records the item transaction performed by the trader TR.

The traceability system 120 is used in combination with the distribution management system 110, and accumulates the transaction record in the same manner as the distribution management system 110. Specifically, the distribution management system 110 corresponds to an old management system, and the traceability system 120 corresponds to a new management system. The traceability system 120 is operated together with the existing distribution management system 110 without substantially changing the distribution management system 110. In addition to a record generation function of accumulating the transaction records, the traceability system 120 has a record reference function of providing the accumulated transaction records in a manner that allows reference thereto. In the traceability system 120, blockchain technology is used to manage the transaction record for the purpose of preventing tampering with the transaction record.

The traceability system 120 collects transaction records using an information code Cd1 based on the item code Ci1 issued by the system server 10. The traceability system 120 includes a code output device 22, a code scanner 23, and a history management server 20. In the traceability system 120, the input terminal 11 and the label printer 12 of the distribution management system 110 can be used. The code output device 22, the code scanner 23, and the input terminal 11 are connected, via a network, to the history management server 20 provided at a data center or the like.

The code output device 22 is provided at the facility of the trader TR where the label printer 12 is provided. The code output device 22 is provided in a manner that intercepts a communication line between the system server 10 and the label printer 12, and acquires data of the item code Ci1 transmitted from the system server 10 to the label printer 12. The code output device 22 transmits the data of the acquired item code Ci1 to the history management server 20.

The code output device 22 receives, from the history management server 20, data of the information code Cd1 that is generated based on the transmitted item code Ci1. The information code Cd1 further records tracking information as secret information used in the traceability system 120. The code output device 22 transmits the data of information code to the label printer 12 instead of the data of item code Ci1. Due to such intervention of the code output device 22, the label printer 12 prints the information code Cd1 on a paper medium without recognizing any modification (substitution) of the acquired code data. As a result, a code printing medium on which the information code Cd1 is printed instead of the item code Ci1 is attached to the item and distributed together with the item.

The label printing medium on which the label printer 12 prints the code has the same layout as the medium on which the item code Ci1 is printed. Therefore, when a display area of the information code Cd1 printed instead of the item code Ci1 is larger than a display area of the item code Ci1, the information code may not fit on the label printing medium. For this reason, it is preferable that the display area of information code Cd1 is equal to or smaller than the display area of the item code Ci1.

The code scanner 23 is a reading device that reads the secret information recorded in the information code Cd1. The secret information is added to the information code Cd1 separately from the public information. Since the code scanner 23 is configured to scan the same target object as the code reading device 13, the code scanner 23 may be physically integrated with the code reading device 13. The code scanner 23 includes an image sensor in which CCD elements are arranged in a two-dimensional array, a signal processing unit 41, and the like. The image sensor is capable of reading information recorded on a planar two-dimensional region at a higher resolution than the code reading device 13. The imaging sensor outputs a captured image in which the information code Cd1 appears (hereinafter referred to as a code captured image) to the signal processing unit 41.

The signal processing unit 41 includes a storage unit that stores a code reading program and the like, a processor that executes a code reading process to be described later based on the code reading program, and a RAM. The processor includes, for example, at least one type of a central processing unit (CPU), a graphics processing unit (GPU), or a reduced instruction set computer (RISC)-CPU as a core.

The signal processing unit 41 performs the code reading process to decode the read signal of image sensor in accordance with a predetermined rule, and obtains the tracking information recorded in the information code Cd1. The signal processing unit 41 may be configured to read information from the history management server 20 based on the acquired tracking information.

The history management server 20 is a host node capable of communicating with the input terminal 11 in addition to the code output device 22 and the code scanner 23. The history management server 20 is mainly implemented by a computer including a processor 31, a RAM 32, a storage medium 33, an input and output interface, and a bus that connects these components. The processor 31 is implemented by a hardware circuit for arithmetic processing, and is coupled to the RAM 32. The processor 31 is mainly implemented by a central processing unit (CPU). The processor includes, for example, at least one type of a central processing unit (CPU), a graphics processing unit (GPU), or a reduced instruction set computer (RISC)-CPU as a core. The processor 31 executes various types of processing related to data management by accessing the RAM 32. The storage medium 33 stores, as a management program related to data management, a code generation program for causing the processor 31 to execute a code generation method according to the present disclosure.

In the traceability system 120, one information code Cd1 may be continuously used for multiple traders TR, or a new information code Cd1 may be generated for each trader TR. In the configuration in which the new information code Cd1 is generated for each trader TR, a latest hash value reflecting the transaction record may be generated in response to occurrence of the transaction record in each trader TR. The history management server 20 newly generates the information code Cd1 in which the latest hash value is recorded as the tracking information, and provides data of the new information code Cd1 to the label printer 12, which is provided at the facility of the trader TR who performs the transaction. As a result, the information code continues to be updated to reflect previous transaction records. Since the tracking information mainly includes the hash value, the amount of data in the tracking information can be maintained constant even as transaction of items progresses in the supply chain SC.

A consumer of the final product can view the transaction records of the final product by using a traceability confirmation application installed on a user terminal 50, such as a smartphone or tablet terminal. Specifically, when the user terminal 50 reads the code attached to the final product (which may be the information code Cd1 or another code issued additionally), the user terminal sends an inquiry request to confirm the transaction record together with the hash value, to the history management server 20 that is the contact point for inquiry. When the history management server 20 receives the confirmation request, the history management server extracts the item information and transaction record associated with the hash value and generates reference data for providing purpose. The history management server 20 transmits the generated reference data to the user terminal 50, which has issued the reference request. The consumer of the final product can check a history of the transaction record by loading the reference data transmitted from the history management server 20 using the traceability check application.

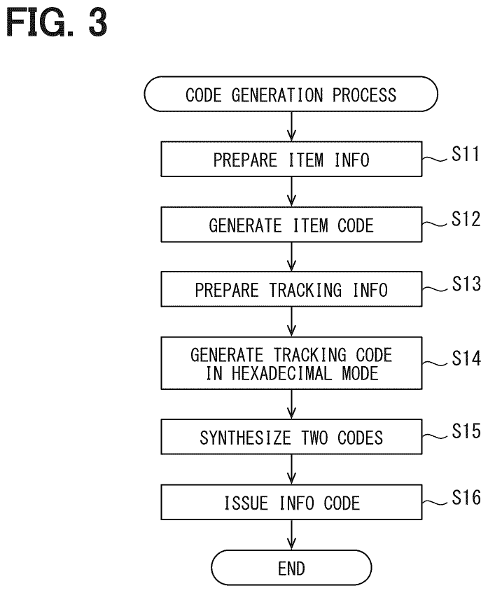

The following will describe the information code Cd1 and the method for generating the information code in detail. A flowchart in FIG. 3 shows an example of a generation method of the information code Cd1. The code generation process shown in S11 to S16 of the flowchart in FIG. 3 is implemented by the processor 31 of the history management server 20 executing a code generation program.

In S11, the history management server 20 prepares item information. The history management server 20 acquires the data of item code Ci1 through the code output device 22. The item information is, for example, 14-digit characters such as “abcdefghijklmn”. After executing S11, the process proceeds to S12. In S12, the history management server 20 generates the item code Ci1 based on the item information. For example, the item code Ci1, which is a QR code, may be generated in 8-bit byte mode, version 2, and correction level of H. The item code Ci1 is expressed by a two-dimensional array of two colored cells including black cells BLC and white cells WHC. In the two-dimensional array of two colored cells, black cells BLC may be converted to “1” and white cells WHC may be converted to “0”. The generation of item code Ci1 includes applying a mask pattern. After executing S12, the process proceeds to S13.

As shown in Table 1, the 8-bit byte mode is a mode in which the characters of the hash value expressed in hexadecimal format are expressed by an eight-digit binary number, that is, expressed in eight bits. The 8-bit byte mode can be said to be an uncompressed format in which the data is in an uncompressed state. The version indicates a size of the code, and the larger the version value, the larger the code size. The size of the code is correlated to the number of cells and also correlated to the display area of the code. The correction level indicates the restoration capability to restore data when part of the code is damaged. For example, there are four correction levels, namely, level L, level M, level Q, and level H, in order from the lowest level to the highest level of restoration capability.

TABLE 1

| 0 | 1 | 2 | 3 |
|---|---|---|---|
| 0011 0000 | 0011 0001 | 0011 0010 | 0011 0011 |
| 4 | 5 | 6 | 7 |
| 0011 0100 | 0011 0101 | 0011 0110 | 0011 0111 |
| 8 | 9 | a | b |
| 0011 1000 | 0011 1001 | 0110 0001 | 0110 0010 |
| c | d | e | f |
| 0110 0011 | 0110 0100 | 0110 0101 | 0110 0110 |

In S13, the history management server 20 prepares the tracking information. The tracking information is, for example, 64 characters such as “fb8e20fc2e4c3f248c60c39bd652f3c1347298bb977b8b4d5903b85055620603”. A hash function such as SHA-256 may be used to generate a hash value, which is used as the tracking information. The hash value is data in which a predetermined number of bits (for example, 256 bits) is maintained. After executing S13, the process proceeds to S14.

In S14, the history management server 20 generates a tracking code Ct1 based on the tracking information. For example, the tracking code Ct1 is generated in hexadecimal mode, version 2, and correction level of L. The tracking code Ct1 is represented by a two-dimensional array of two colored cells including black cells BLC and white cells WHC. The generation of tracking code Ct1 includes applying a mask pattern. After executing S14, the process proceeds to S15.

As shown in Table 2, the hexadecimal mode is a mode in which the characters of the hash value in hexadecimal format are expressed by a four-digit binary number, that is, represented in four bits. The hexadecimal mode is considered as a compressed format. That is, by expressing the tracking information in hexadecimal mode and also lowering the correction level, even if the amount of tracking information is greater than the amount of item information, it is possible to display the tracking code Ct1 in a size or display area as the same size or the same display area of the item code Ci1, that is, version 2.

TABLE 2

| 0 | 1 | 2 | 3 | 4 | 5 | 6 | 7 |
|---|---|---|---|---|---|---|---|
| 0000 | 0001 | 0010 | 0011 | 0100 | 0101 | 0110 | 0111 |
| 8 | 9 | a | b | c | d | e | f |
| 1000 | 1001 | 1010 | 1011 | 1100 | 1101 | 1110 | 1111 |

The mode of the code can be determined by embedding a mode indicator in the code. The correspondence between the modes and the mode indicators can be set as shown in Table 3. As shown in Table 3, the hexadecimal mode can be determined by assigning the hexadecimal mode to the mode indicator.

TABLE 3

| Mode | Indicator |
|---|---|
| Numeric Number | 0001 |
| Alphanumeric Number | 0010 |
| 8-bit byte | 0100 |
| Chinese Character | 1000 |
| Hexadecimal number | 0110 |

The number of characters expressed in each mode can be read by embedding a character number indicator in the code. The bit number of character number indicator varies depending on the mode and version, but is a multiple of four.

TABLE 4

| | Numeric | Alphanumeric | 8-bit | Hexadecimal |
|---|---|---|---|---|
| Version | Number | Number | byte | Number |
| 1-9 | 10 | 9 | 8 | 12 |
| 10-26 | 12 | 11 | 16 | 12 |
| 27-40 | 14 | 13 | 16 | 16 |

In the code, the data structure is written in the order of, for example, mode indicator, character number indicator, data, termination pattern, padding bit, and padding word.

In S15, the history management server 20 synthesizes the item code Ci1 and the tracking code Ct1. That is, the item code Ci1 and the tracking code Ct1 are stored in superimposed manner on a common two-dimensional region as the information code Cd1. After executing S15, the process proceeds to S16.

The following will describe a method for synthesizing the item code Ci1 and the tracking code Ct1. The color of each cell of the information code Cd1 after synthesis is determined automatically according to a preset synthesis rule. The synthesis rule may be set as the rule shown in Table 5.

TABLE 5

| Cdi | Cdt | Cd2 |
|---|---|---|
| Black | Black | Black |
| Black | White | Dark Color |
| White | Black | Light Color |
| White | White | White |

According to the synthesis rule in Table 5, for the cells to be superimposed with one another, when the item code Ci1 is a black cell BLC and the tracking code Ct1 is a black cell BLC, the information code Cd1 after synthesis is set to a black cell BLC. For the cells to be superimposed with one another, when the item code Ci1 is a white cell WHC and the tracking code Ct1 is a white cell WHC, the information code Cd1 after synthesis is set to a white cell WHC. For the cells to be superimposed with one another, when the item code Ci1 is a black sell BLC and the tracking code Ct1 is a white cell WHC, the information code Cd1 after synthesis is set to a dark color cell DCC. For the cells to be superimposed with one another, when the item code Ci1 is a white sell WHC and the tracking code Ct1 is a black cell BLC, the information code Cd1 after synthesis is set to a light color cell LCC.

The dark color is a color that is perceived by a reading device as having a lower brightness than the white color or the light color, such as red. The light color is a color that is perceived by a reading device as having a higher brightness than the black color or the dark color, such as yellow. In this way, the synthesized information code Cd1 is expressed by an arrangement of cells in multiple colors (maximum four colors).

In S16, the history management server 20 issues the synthesized information code Cd1. That is, the new information code Cd1 is printed on a label printing medium by the label printer 12 provided at the facility of the trader TR. At this time, in the tracking code Ct1 before synthesis, the display area of the tracking code Ct1 is compressed by using the compression mode in order to match the display area of the item code Ci1, so that the display area of the information code Cd1 after synthesis also matches the display area of the item code Ci1. Therefore, the label printing medium on which the item code Ci1 was previously printed can be continually used as is. The process is ended after executing S16.

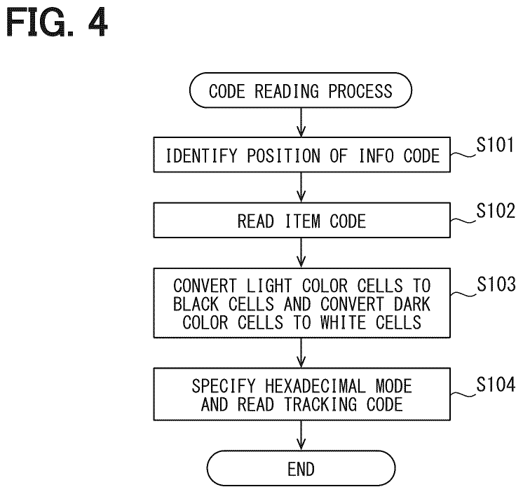

The following will describe a method of reading the information code Cd1 in detail. The flowchart of FIG. 4 shows an example of a method of reading the information code Cd1. In the code reading process of FIGS. 4, S101 to S104 are implemented by the processor of the code scanner 23 when executing a code reading program.

In S101, the code scanner 23 identifies a position of the information code Cd1 based on the captured code image. After executing S101, the process proceeds to S102.

In S102, the code scanner 23 reads the item code Ci1 using a first reading method. After executing S102, the process proceeds to S103.

The first reading method is substantially the same as the method for reading a code expressed in two colors, white and black, such as the item code Ci1 before synthesis. That is, the code scanner 23 performs binarization processing on each cell of the code based on a brightness threshold value, and reads the information. The brightness threshold is set between the brightness of dark color and the brightness of the light color. Therefore, the black cell BLC and the dark color cell DCC are recognized as the black cell BLC. The white cell WH1 and the light color cell LCC are recognized as the white cell WHC.

Based on the synthesis rule in Table 5, the black cell BLC and the dark color cell DCC of the information code Cd1 correspond to the black cell BLC of the item code Ci1, and the white cell WHC and the light color cell LCC of the information code Cd1 correspond to the white cell WHC of the item code Ci1. Therefore, the item information stored in the item code Ci1, which is synthesized in the information code Cd1, can be read out by the first reading method described above. When reading out the item information, it is necessary to remove the mask pattern applied in S12.

In S103 and S104, the code scanner 23 reads out the tracking code Ct1 using a second reading method that is different from the first reading method. Specifically, in S103, for the cells of information code Cd1 recognized in the code image, the code scanner 23 performs image processing to convert the light color cells LCC into black cells BLC and the dark color cells DCC into white cells WHC. After executing S103, the process proceeds to S104.

After the image processing in S103 is finished, in S104, the code scanner 23 reads information from the information code Cd1 using the first reading method. That is, the black cells BLC and light color cells LCC of the information code Cd1 before image processing are recognized as black cells BLC. The white cells WHC and dark color cells DCC of the information code Cd1 before image processing are recognized as white cells WHC.

According to the synthesis rule of Table 5, the black cell BLC and light color cell LCC of the information code Cd1 correspond to the black cell BLC of the tracking code Ct1, and the white cell WHC and dark color cell DCC of the information code Cd1 correspond to the white cell WHC of the tracking code Ct1. Therefore, the tracking information stored in the tracking code Ct1, which is synthesized in the information code Cd1, can be read out by the second reading method described above. The synthesis rule shown in Table 5 is an innovative rule that generates an information code Cd1 using an arrangement of multiple color cells under a condition that the brightness determination of cells of the item code Ci1 determined using the first reading method is maintained and reading of the tracking code Ct2 using the second reading method is enabled.

The code scanner 23 refers to the mode indicator and determines that the information of the tracking code Ct1 is stored in hexadecimal mode. The code scanner 23 refers to the character number indicator to identify the range of cells to which the hexadecimal mode is applied. The code scanner 23 then reads out the tracking information by restoring the information in each cell according to the expression in hexadecimal mode. When reading out the tracking information, it is necessary to remove the mask pattern applied in S14. The process is ended after executing S104.

In the first embodiment, the item code Ci1 corresponds to a first code and the item information corresponds to first information. The tracking code Ct1 corresponds to a second code and the tracking information corresponds to second information. The history management server 20 corresponds to an information code generation device. The code scanner 23 corresponds to an information code reading device.

According to the first embodiment described above, for one code in which each data is expressed in an uncompressed format, an uncompressed format is adopted such that the code can be expressed in a smaller display area. For the other code, a compressed format is adopted such the display area of the code can be compressed. By creating a difference between the uncompressed format and the compressed format, the difference between the display area of the first code and the display area of the second code can be reduced. The display area of the information code Cd1 after superimposition can be adjusted to be the same as or close to one code that can be expressed with a smaller display area. Therefore, the applicability of the superimposed information code Cd1 to the display layout can be improved, thereby providing high convenience.

According to the first embodiment, the compressed format is a format in which the display area is compressed by expressing the hash value in four bits. The hash value in hexadecimal number is expressed in eight bits per character in the uncompressed format. By compressing the amount of data indicating the hash value in this way, the display area can be easily compressed.

According to the first embodiment, the information code Cd1 is displayed in a form printed on a code printing medium. When the information code Cd1 is printed on a code printing medium, it is more difficult to change the layout and size of the code printing medium, so it is extremely suitable to employ a superimposed code generated in the compressed format.

According to the first embodiment, when a code expressed in a compressed format in which the display area is compressed is identified, information is read out in accordance with the compression mode of the compressed format. Therefore, when reading the information code Cd1 in which the first code and the second code are superimposed, it is possible to obtain the information correctly even if the data of at least one of these codes is expressed in a compressed format. Therefore, this configuration can provide improved convenience.

### Second Embodiment

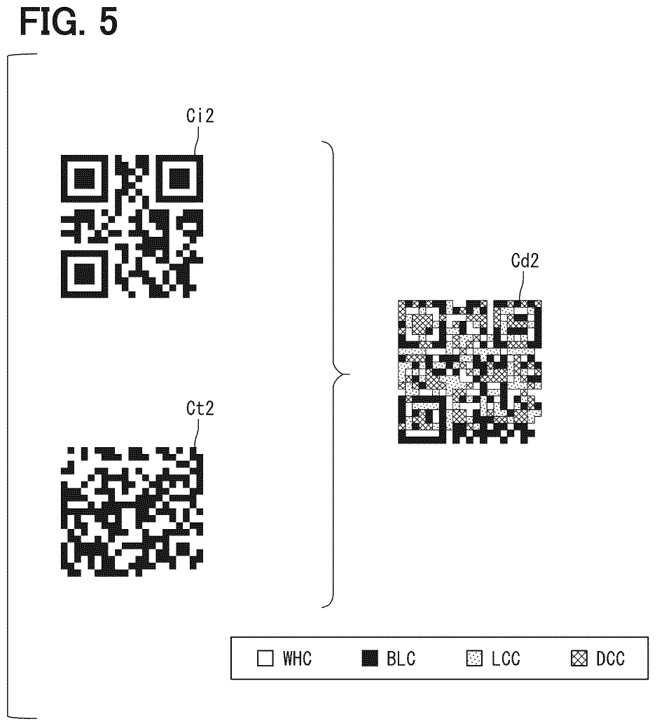

As shown in FIG. 5 to FIG. 8, the second embodiment is a modification of the first embodiment. The second embodiment will be described focusing on differences from the first embodiment.

In the second embodiment, the tracking code Ct2 employs a hexadecimal mode and a compressed format in which function patterns P1 to P5 are deleted. The function patterns P1 to P5 include multiple cells arranged at predetermined positions. The function patterns P1 to P5 are patterns that do not record data itself, but are patterns that ensure readability of the code. As shown in FIG. 5, the information code Cd2 is generated by a process of synthesizing an item code Ci2 having function patterns P1 to P5 and a tracking code Ct2 from which function patterns P1 to P5 have been removed.

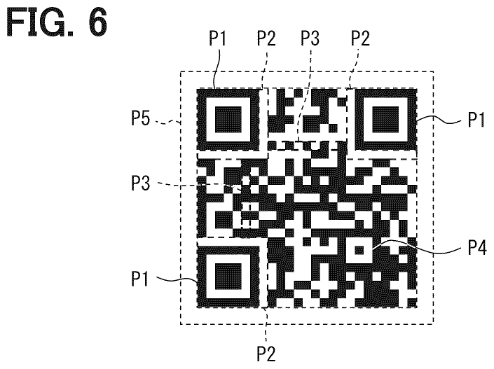

FIG. 6 shows an example of a code having function patterns P1 to P5. For example, the function patterns include a position detection pattern P1, a separation pattern P2, a timing pattern P3, an alignment pattern P4, and a quiet zone P5.

The position detection pattern P1 is also referred to as a finder pattern. The position detection patterns P1 are arranged at three of the four corners of the code (for example, upper right, upper left, and lower left). For example, one position detection pattern P1 includes 7 cells×7 cells, that is, 49 cells. The position detection pattern P1 has a shape in which three concentric squares are overlapped on each other, and the three concentric squares are composed of black 7×7 module, white 5×5 module, and black 3×3 module, respectively. Since the position detection patterns P1 are arranged at the three corners, the code scanner 23 can identify the lower right direction of the code.

The separation pattern P2 is arranged in the boundary portion of each position detection pattern P1, excluding the outer periphery of the code. The separation pattern P2 is made up entirely of white cells WHC, and clearly separates the position detection pattern P1 from remaining part of the code.

The timing pattern P3 is a linear pattern arranged to connect two position detection patterns P1 together, and is configured so that white cells WHC and black cells BLC are arranged alternately. The timing pattern P3 is provided to determine the size of one cell.

The alignment pattern P4 is a pattern that is arranged at internal portion of the code. One or more alignment patterns P4 are arranged depending on the version. For example, one alignment pattern P4 may include 5 cells×5 cells, that is, 25 cells. The alignment pattern P4 may be in the form of three overlapping concentric squares, that is, a black 5×5 module, a white 3×3 module, and a central black module. When multiple alignment patterns P4 are arranged, they are arranged at predetermined intervals from one another. The alignment pattern P4 is provided to correct distortions that may occur on the display surface of code printing medium or the like, thereby ensuring readability of the code.

The quiet zone P5 is arranged so as to surround the entire outer periphery of the code. The quiet zone P5 is made up entirely of white cells WHC, and clearly separates the code from periphery.

In the example of the first embodiment, the function patterns P1 to P5 are patterns common to the item code Ci1 and the tracking code Ct1, and therefore there is no need to provide the functional patterns to both of the item code Ci1 and the tracking code Ct1. By deleting the function patterns P1 to P5 from the tracking code Ct2, which has the larger amount of data, the display area of the tracking code Ct2 can be more easily adjusted to match the display area of the item code Ci2.

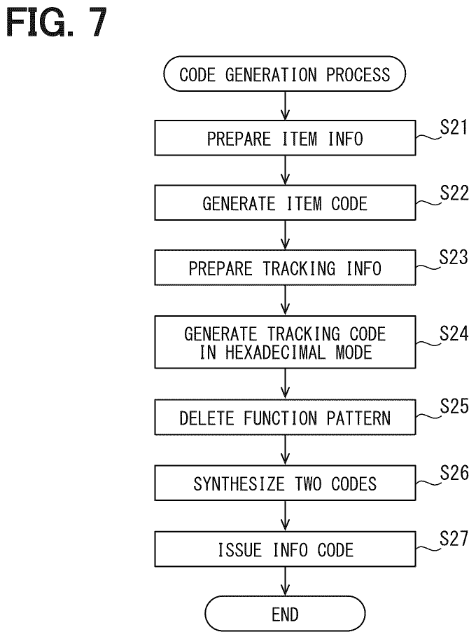

The information code Cd2 and the generation method of information code will be described in detail. The flowchart in FIG. 7 shows an example of a generation method of the information code Cd2. The code generation process shown in S21 to S27 of the flowchart in FIG. 7 is implemented by the processor 31 of the history management server 20 executing a code generation program.

S21 to S24 are the same as S11 to S14 in the first embodiment. In S21, the item information is a 13-digit number such as “1234567890123”. The item code Ci2 is then generated in numeric mode, version 1, and correction level L.

After executing S24, the process proceeds to S25. In S25, the history management server 20 deletes the function patterns P1 to P5 of the tracking code Ct2. Here, all of the function patterns P1 to P5 are deleted. After executing S25, the process proceeds to S26.

The tracking code Ct2 generated in S23 is version 2. As shown in Table 6, the number of cells required for function patterns P1 to P4 of version 2 is 235 in total. The total number of cells in version 2 is 625, so the total number of cells in tracking code Ct2 excluding function patterns P1 to P5 is 390. The total number of cells in version 1 is 441, which is more than 390. That is, when the function patterns P1 to P4 are deleted from the tracking code Ct2 of version 2, it is possible to record information in a display area smaller than the display area of version 1.

TABLE 6

| Version 2 | |
|---|---|
| Function Patterns | Cell Number |
| Position Detection | 147 |
| Separation | 45 |
| Alignment | 25 |
| Timing | 18 |
| Total | 235 |

It should be noted that rather than generating the tracking code Ct2 that does not initially include function patterns P1 to P4, the tracking code Ct2 that includes function patterns P1 to P4 is generated in S24, and then the function patterns P1 to P4 are deleted in S25. This is because if the mask pattern is not applied in S24, it will be difficult to restore the tracking code Ct2, from which the function patterns P1 to P4 have been removed, to a normal code having the function patterns P1 to P5 when reading the tracking code.

In S26, the history management server 20 synthesizes the item code Ci2 including the function patterns P1 to P5 with the tracking code Ct2 from which the function patterns P1 to P4 have been removed, as shown in FIG. 5. The synthesis rule may be the same as the synthesis rule of the first embodiment. After executing S26, the process proceeds to S27. The process executed in S27 is the same as S16 in the first embodiment. The process is ended after executing S27.

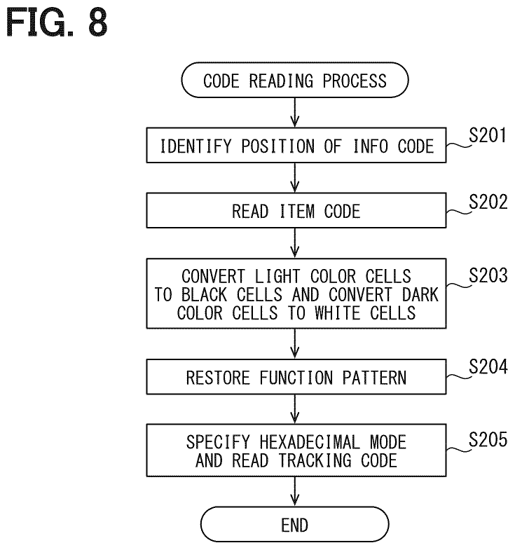

The following will describe a method of reading the information code Cd12in detail. The flowchart of FIG. 8 shows an example of a method of reading the information code Cd2. In the code reading process of FIGS. 8, S201 to S205 are implemented by the processor of the code scanner 23 when executing a code reading program.

S201 to S203 are the same as S101 to S103 in the first embodiment. After executing S203, the process proceeds to S204.

In S204, the history management server 20 restores the function patterns P1 to P4 from the tracking code Ct2 from which the function patterns P1 to P4 have been removed. By adding the function patterns P1 to P4 to the tracking code Ct2 from which the function patterns P1 to P4 have been removed, the tracking code Ct2 with mask pattern is generated. After executing S204, the process proceeds to S205. S205 is the same as S104 in the first embodiment. The process is ended after executing S205.

According to the second embodiment described above, the display area is compressed in the compressed format by removing at least some of the multiple function patterns P1 to P5, which are used to recognize the code in the uncompressed format. Regarding the function patterns that are common between the item code Ci2 and the tracking code Ct2, for one code that is required to be compressed, the function patterns are deleted from the one code. As a result, the information code Cd2 after superimposition can provide high applicability to display layout while retaining the functionality of the function pattern.

### Third Embodiment

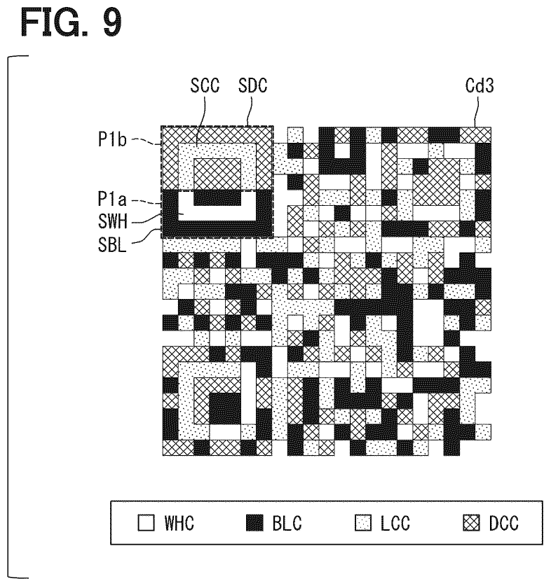

As shown in FIG. 9, the third embodiment is a modification of the second embodiment. The third embodiment will be described focusing on differences from the second embodiment.

The number of cells in the tracking code Ct2 of the second embodiment, excluding the function patterns P1 to P5, is 390. Therefore, remaining 51 cells can be configured in colored cells. The remaining 51 cells is the difference of effective cells of tracking code Ct2 from the 441 cells of version 1. In the third embodiment, a color sample region for presenting a sample color is arranged in the remaining cells.

Specifically, the synthesized information code Cd3 of the third embodiment is configured by superimposing a color sample region on the function pattern. Out of the function patterns P1 to P5, a color sample region is superimposed on the upper left position detection pattern P1.

In the third embodiment, among the function patterns P1 to P5 of the tracking code Ct2, the history management server 20 deletes all function patterns except the upper left position detection pattern P1 in S25, leaving only the upper left position detection pattern P1. In S26, the history management server 20 does not apply the synthesis rule of Table 5 to only the upper left position detection pattern P1, and forms a color sample region by superimposing the color sample region on the position detection pattern P1.

For example, of the region of 7×7 cells of the position detection pattern P1, the lower region P1a of 3×7 cells is made up of black cells BLC and white cells WHC, same as the normal position detection pattern P1. In this case, the lower region of 3×7 cells serves as both the sample region SBL of the black cells BLC and the sample region SWH of the white cells WHC.

In the upper region P1b of 4×7 cells out of the position detection pattern P1 of 7×7 cells, the black cells BLC are replaced with the dark color cells DCC, and the white cells WHC are replaced with the light color cells LCC. In this case, the upper region P1b of 4×7 cells serves as both the sample region SDC of the dark color cell DCC and the sample region SLC of the light color cell LCC.

Four colored sample regions SBL, SWH, SDC, and SLC are superimposed on the function pattern P1. This allows the information code Cd3 to inform the reading device of the color combinations being used in the code. When the information code Cd3 is printed with ink on a code printing medium such as paper, the ink may fade over time, but the same fading occurs in the color sample region and the data storage region, so it is possible to correct the color of the data storage region based on the color of the color sample region and when reading the code.

### Other Embodiments

While multiple embodiments are described above, the present disclosure is not interpreted as being limited to the embodiments and can be applied to various embodiments and combinations without departing from a spirit of the present disclosure.

In another embodiment, the history management server 20 may generate the tracking code in 8-bit mode instead of the hexadecimal mode, and then delete the function patterns P1 to P5 and compress the tracking code to fit the display area of the item code.

In another embodiment, the history management server 20 may delete only a part of the function patterns P1 to P5 (for example, only the position detection pattern P1 having the largest number of cells among the function patterns P1 to P5). In this case, a deletion pattern identifier may be added to the data structure to identify which of the function patterns P1 to P5 has been deleted.

In another embodiment, when the display area of the item code expressed in uncompressed format is larger than the display area of the tracking code expressed in uncompressed format, the history management server 20 may generate the item code in compressed format and the tracking code in uncompressed format.

In another embodiment, colors other than red and yellow may be used in combination of colors to configure the light and dark colors. For example, in the information codes Cd1, Cd2, and Cd3 that are printed on the code printing medium using only monochrome ink without using color ink, the light color may be light gray and the dark color may be dark gray. Color density does not have to be expressed by only one ink color, but may be expressed by a mixture of multiple ink colors on the display surface of the code printing medium or by differences in ink density.

In another embodiment, the final product supplied by the supply chain SC using the information codes Cd1, Cd2, Cd3 may be changed as appropriate. For example, the traceability system 120 may manage various items such as an automobile, a battery, a semiconductor, fresh food, an aquatic product, sediment, food, flowers, a pharmaceutical, or a chemical product.

In another embodiment, the information codes Cd1, Cd2, and Cd3 may be used by a system other than the distribution management system 110 and the traceability system 120. The information recorded in the code before synthesis is not limited to the above-mentioned item information and tracking information, but may be changed as appropriate depending on the use of the information codes Cd1, Cd2, and Cd3. For example, instead of the above-described hash value, a unique identification (UID) that identifies the item shipped from the trader TR may be recorded as the secret information.

In another embodiment, the functions provided by the history management server 20 and the code scanner 23 can be provided by software and hardware that executes the functions, software only, hardware only, or a combination of the software and hardware. In a case where such functions are provided by an electronic circuit as hardware, each of the functions can also be provided by (i) a digital circuit including a large number of logic circuits or (ii) an analog circuit.

The devices and methods described in the present disclosure may be implemented by a special purpose computer provided by configuring a processor programmed to execute one or more functions embodied by a computer program. Alternatively, the devices and methods described in the present disclosure may be implemented by a dedicated hardware logic circuit. Alternatively, the devices and methods described in the present disclosure may be implemented by one or more dedicated computers including a combination of a processor executing a computer program and one or more hardware logic circuits. The computer program may be stored on a computer-readable, non-transitory storage medium as instructions to be executed by a computer.

What is claimed is:

1. A display medium for displaying an information code, the display medium comprising the information code,
wherein
the information code includes:
a first code representing first information; and
a second code representing second information,
the first code and the second code are recorded in a two-dimensional region in a superimposed manner,
the first code is displayed in the two-dimensional region and is readable by performing a brightness determination using a first reading method,
the second code is displayed in the two-dimensional region and is readable using a second reading method, which is different from the first reading method,
in the second code, an arrangement of multiple colored cells is defined under a condition that a result of the brightness determination performed using the first reading method is maintained when reading the second code using the second reading method, and
among the first code and the second code, one code expresses data in an uncompressed format and is displayed in a smaller display area compared with the other code, and the other code expresses data in a compressed format for compressing a display area of the other code.

2. The display medium according to claim 1, wherein,
in the uncompressed format, a hash value represented as a hexadecimal number is expressed in 8 bits per character, and
in the compressed format, the display area is compressed by expressing the hash value in 4 bits per character.

3. The display medium according to claim 1, wherein,
in the compressed format, the display area is compressed by removing at least a part of function patterns, which are used for code recognition purpose in the uncompressed format.

4. The display medium according to claim 3, wherein,
in the compressed format, at least a part of function patterns of the other code is removed while a remaining part of function patterns is left, and
in a region where the remaining part of function patterns is displayed, colors of all of the multiple colored cells are arranged as sample colors under the condition that the result of brightness determination performed using the first reading method is maintained.

5. The display medium according to claim 3, wherein
an identifier is added to the other code to distinguish the function patterns, which are removed, from the function patterns, which are left, among all of the function patterns.

6. The display medium according to claim 1, wherein
the information code is displayed in printed form on a printing medium.

7. An information code generation device comprising at least one processor, wherein
the at least one processor is configured to generate an information code in which a first code representing first information and a second code representing second information are recorded in a two-dimensional region in a superimposed manner,
the at least one processor is further configured to:
generate the first code that is readable by performing a brightness determination using a first reading method; and
generate the second code,
in generation of the first code and the second code, one code is generated to express data in an uncompressed format and displayed in a smaller display area compared with the other code, and the other code is generated to express data in a compressed format for compressing a display area of the other code,
the at least one processor is further configured to synthesize the first code and the second code based on a synthesis rule, which enables the second code to be readable by a second reading method, which is different from the first reading method, and
in the second code, an arrangement of multiple colored cells is defined under a condition that a result of the brightness determination performed using the first reading method is maintained when reading the second code using the second reading method.

8. The information code generation device according to claim 7, wherein,
in the uncompressed format, a hash value represented as a hexadecimal number is expressed in 8 bits per character, and
in the compressed format, the display area is compressed by expressing the hash value in 4 bits per character.

9. The information code generation device according to claim 7, wherein,
in the compressed format, the display area is compressed by removing at least a part of function patterns, which are used for code recognition purpose in the uncompressed format.

10. An information code reading device comprising at least one processor, wherein
the at least one processor is configured to read an information code in which a first code representing first information and a second code representing second information are recorded in a two-dimensional region in a superimposed manner,
the information code includes white cells, black cells, light color cells, and dark color cells, and
the at least one processor is further configured to:
read the first code by performing a brightness determination using a first reading method in which (i) the white cells and the light color cells are determined to have a same value and (ii) the black cells and the dark color cells are determined to have a same value;
read the second code by performing a brightness determination using a second reading method in which (i) the white cells and the dark color cells are determined to have a same value and (ii) the black cells and the light color cells are determined to have a same value; and
in at least one of reading the first code or reading the second code, identify one code expressed in a compressed format in which a display area of the one code is compressed and read information stored in the one code according to a compressed mode of the compressed format.

11. The information code reading device according to claim 10, wherein,
in an uncompressed format, a hash value represented as a hexadecimal number is expressed in 8 bits per character, and
in the compressed format, the display area is compressed by expressing the hash value in 4 bits per character.

12. The information code reading device according to claim 10, wherein,
in the compressed format, the display area is compressed by removing at least a part of function patterns, which are used for code recognition purpose in an uncompressed format.
